(19) United States
(12) Patent Application Publication
(10) Pub. No.: US 2019/0021288 A1
(43) Pub. Date: Jan. 24, 2019

(54) STRUCTURED EXERCISE DEVICE AND METHOD THEREOF FOR TRAINING DOGS

(71) Applicant: HUI-PI HUANG, TAIPEI CITY (TW)

(72) Inventors: HUI-PI HUANG, TAIPEI CITY (TW); YU-HSIN LIEN, TAIPEI CITY (TW)

(21) Appl. No.: 15/653,925

(22) Filed: Jul. 19, 2017

(51) Int. Cl. A01K 15/02; A01K 15/00

(52) U.S. Cl. CPC A01K 15/027; A01K 15/02; A01K 15/00

(57) ABSTRACT

Structured exercise comprises aerobic exercise and resistance training A structured exercise device and method thereof are utilized to train dogs with chronic diarrhea. The dog performs 3 to 5 repetitions of 10-180 seconds of the aerobic exercise on a stepping section of the device, then takes a break for 5-15 minutes, and proceeds 3 to 5 repetitions of 30-180 seconds of the resistance training on the stepping section of the device in inclined state. The dog may take a break for 1-5 minutes between every repetition of the aerobic exercise or the resistance training. The structured exercise is advised to perform 3 to 5 days per week.

### BACKGROUND OF THE INVENTION

### Filed of the Invention

This present invention relates to a structured exercise device and method thereof, more particularly to the device and method thereof for training dogs to perform structured exercise.

### Description of the Related Prior Art

Chronic enteropathy is characterized by persistent or recurrent gastrointestinal signs, such as diarrhea or vomiting, for more than three weeks. In dogs, food-responsive diarrhea, antibiotic-responsive enteropathy and inflammatory bowel disease (IBD) are common causes of persistent or recurrent chronic diarrhea in dogs. The term “inflammatory bowel disease” is a chronic gastrointestinal disorder of unknown etiology and applied in veterinary medicine to idiopathic inflammation arising from any area of the gastrointestinal tract.

It has been reported that more than 50 percent of dogs with IBD require long-term or lifelong treatment; however, less than 50 percent of dogs with IBD respond well to initial treatment with immunosuppressant agents. In addition, long-term use of antibiotics can negatively affect quality of life for dogs even if clinical signs of IBD are controlled. More than 10 percent of dogs with IBD become refractory to treatment and are euthanized.

### SUMMARY OF THE INVENTION

Conventional treatment for dogs with IBD including chronic diarrhea is taking a combination of medications (mainly the anti-inflammatory drugs). Though medications often result in positive treatment effect, there are still undesirable side effects that negatively affect the dog's quality of life. Consequently, it is necessary to develop an approach which may reduce the dosage and therefore improve the quality of life for dogs with IBD.

The present invention provides a structured exercise device and method thereof for training dogs to control or diminish the symptoms of chronic diarrhea. This invention is not meant to explore the exact mechanisms by which the structured exercise improves the clinical symptoms of chronic diarrhea in dogs.

The structured exercise comprises aerobic and resistance activities. All targeted dogs in the invention lived exclusively indoors, with no involvement in any type of exercise—not even regular walks.

Weight loss is a major clinical sign associated with chronic diarrhea in dogs. By implementing the present invention, all dogs in the exercise group had gained weight and their activity level and appetite had also improved; besides, the dogs' owners reported no side effect of the structured exercise.

This invention demonstrated that utilizing the structured exercise device and method thereof for training dogs with chronic diarrhea well-controlled the symptoms with no negative effect on general health in dogs.

### BRIEF DESCRIPTION OF THE DRAWINGS

FIG. 1 is a schematic drawing of a structured exercise device in the present invention.

FIG. 2 illustrates a schematic drawing of dog trotting on the device in the present invention.

FIG. 3 is a schematic drawing of the ascending state of a slop member of the device in the present invention.

FIG. 4 illustrates a schematic drawing of dog standing on the device in inclined state in the present invention.

FIG. 5 is a flowchart of utilizing the device for training dogs.

### DESCRIPTION OF THE PREFERRED EMBODIMENTS

Hereinafter, embodiments of the invention will be explained in detail with reference to the drawings; however, the invention is not limited thereto.

### Assessment and Selection of Targeted Dogs

Dogs with chronic diarrhea (for greater than or equal to 3 months with or without vomiting) and no or incomplete response to hypoallergenic elimination or hydrolyzed diet regimens for greater than or equal to 2 months and poor response to symptomatic therapies (parasiticides, antibiotics, anticholinergics, pancreatic enzyme supplements and gastrointestinal protectants) were included in this invention. Dogs with pancreatic and neoplastic diseases were excluded using canine pancreatitis lipase immunoreactivity assay and abdominal ultrasonographic examination. All dogs included in the invention lived exclusively indoors, with no involvement in any type of exercise or regular walks.

All dogs selected in this invention underwent routine diagnostic examination procedures comprising hematology, plasma biochemistry profile, urinalysis, fecal parasitology, abdominal radiography and ultrasound to evaluate identifiable causes of chronic diarrhea. Anthelmintic treatment (single dose of praziquantel/pyrantel pamoate/febantel as a broad spectrum anthelmintic agent; five days of sulfadimethoxine for coccidiosis and seven days of metronidazole for giardiasis) was administered to dogs that had not been dewormed within the previous two months. All dogs selected in this invention received oral prednisolone (1 mg/kg/day for 14 days, followed by a tapering dosage) for 10 weeks, as shown in Table 1 below. The owners were advised to provide the same diet for their dogs during the period of this invention.

### Group Allocation

After 4 weeks of prednisolone treatment, dogs were assigned to either the exercise or control group on the basis of the owner's compliance and lifestyle. A certified canine rehabilitation therapist instructed the owners of the dogs in the exercise group on guiding their dogs in the structured exercise. Owners of the dogs in the control group were instructed to maintain their dogs' routine lifestyle.

### Definition of the Structured Exercise

The structured exercise comprises aerobic and resistance activities performed 3 to 5 days per week. Aerobic exercise consisted of one set of trotting for 10˜180 seconds (3 to 5 repetitions per set). The dogs may take a break for 1 to 5 minutes between every repetition. If dogs trot over 3 minutes, they would feel uncomfortable. The trot is a two-beat diagonal gait of the dog where the diagonal pairs of legs move forward at the same time with a moment of suspension between each beat. It has a wide variation in possible speeds.

Resistance training consisted of one set of standing on a 6˜45° incline for 30˜180 seconds (3 to 5 repetitions per set). The dogs may take a break for 1 to 5 minutes between every repetition. Likewise, if dogs stand on an incline over 3 minutes, they would feel uncomfortable. Standing on the 6˜45° incline not only increases lean muscle mass of dog's hind legs, but also improves nutritional status, nutritional metabolism in skeletal muscle and vascular function.

The structured exercise is advised to perform 3 to 5 days per week in order to well-control the symptom of dogs with non-dietary/antibiotic-responsive chronic diarrhea. The dogs may solely perform the aerobic exercise or the resistance training in one day; however, the preferred embodiment is that after performing the aerobic exercise, the dogs may take a break for 5 to 15 minutes, and then perform the resistance training. The structured exercise performance was rechecked in each dog in the exercise group weekly by the same certified canine rehabilitation therapist.

### Structured Exercise Device for Training Dogs

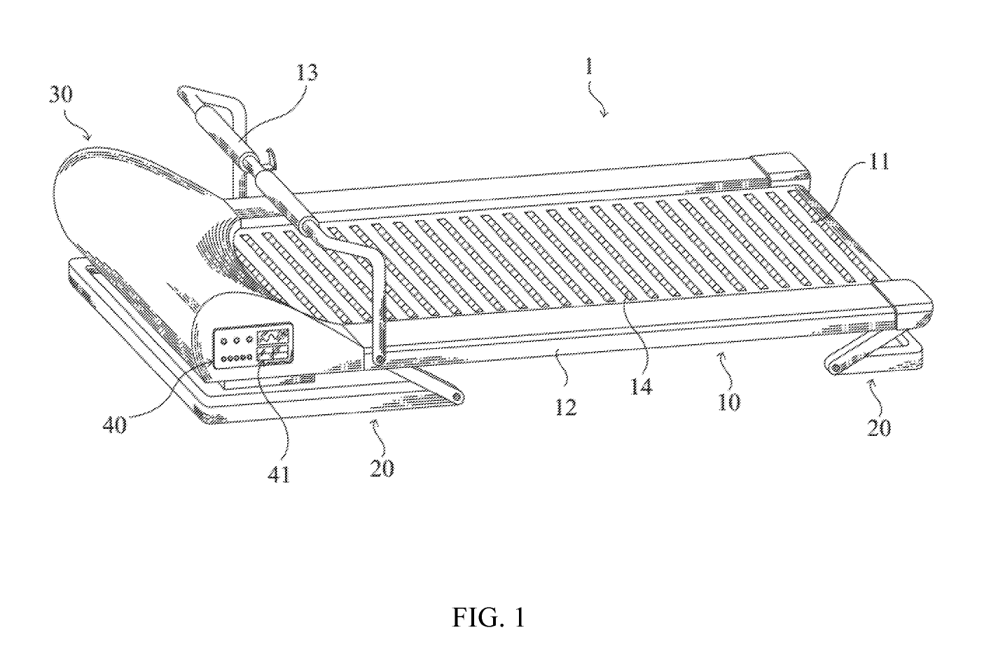

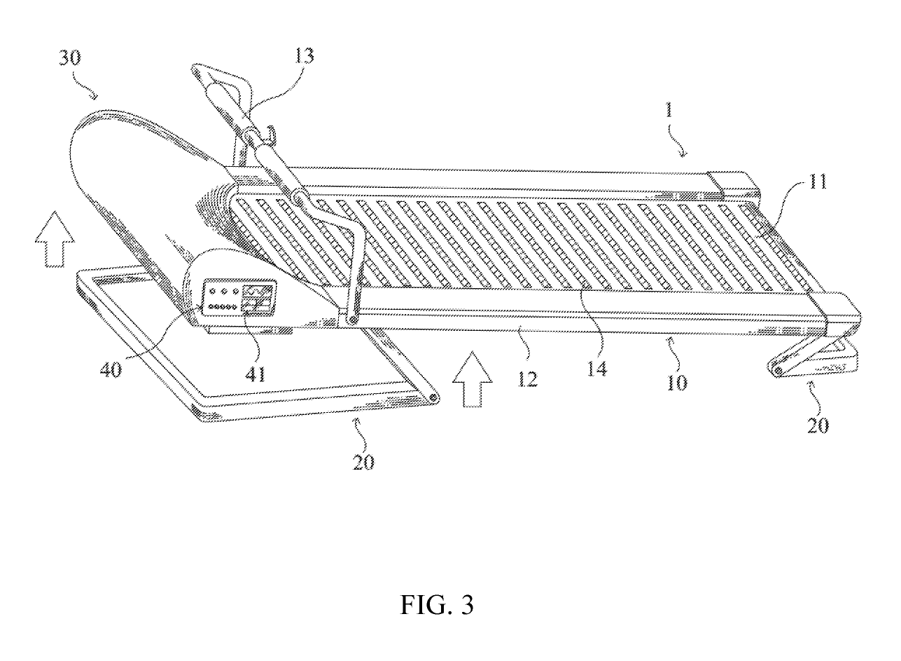

Please refer to FIG. 1 and FIG. 3. A structured exercise device 1 for training dogs comprises a baseplate 10 which includes a stepping section 11, a peripheral side 12 that laterally delimits the space of the stepping section 11 and at least one fixation object 13 which is used for fastening a dog, wherein a plurality of non-slip objects 14 are set on the stepping section 11; a slop member 20 which is arranged at the bottom of the baseplate 10, the ascending state of the slop member 20 makes the baseplate 10 become 6˜45° incline illustrated in FIG. 3; a drive member 30 which is arranged on the baseplate 10, the drive member 30 can regulate the operating speed of the stepping section 11; and an operation unit 40 which is arranged on the peripheral side 12 or the drive member 30, the operation unit 40 includes a microprocessor and a timer 41 and electrically connects with the slop member 20 and the drive member 30, wherein the timer 41 is coupled with the microprocessor and provides a predetermined time, the microprocessor controls the ascending or descending state of the slop member 20 or the drive member 30 to operate or stop to regulate the operating speed of the stepping section 11 between 0.5˜2 kilometers per hour (0.5˜2 km/h) within the predetermined time.

The stepping section 11 in the device may use a stepping board or a stepping belt, and the plurality of non-slip objects 14 are multiple grooves, multiple convex tablets or a combination of both.

### Method of Utilizing the Structured Exercise Device for Training Dogs

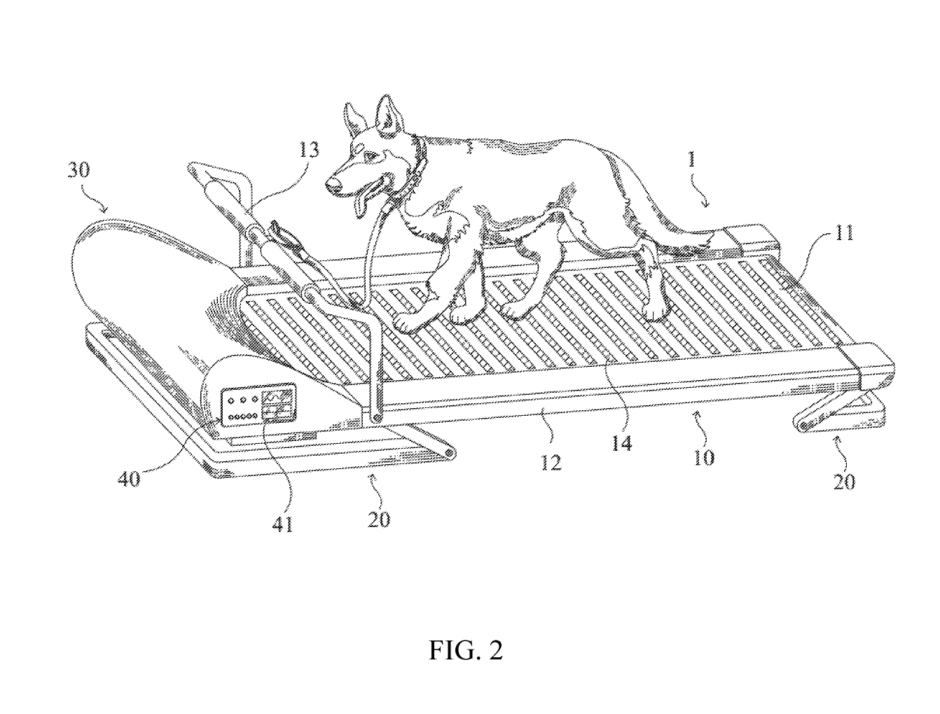

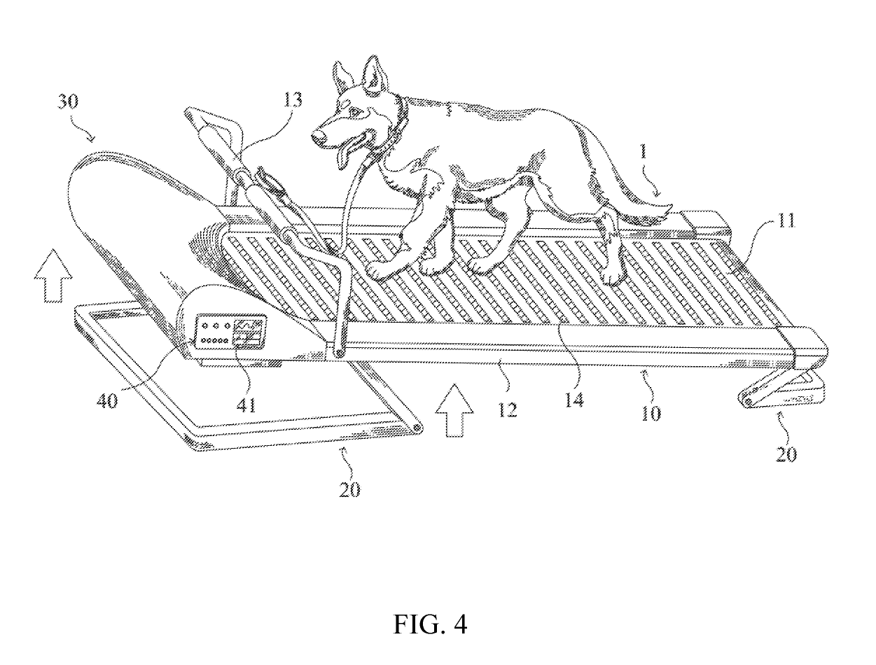

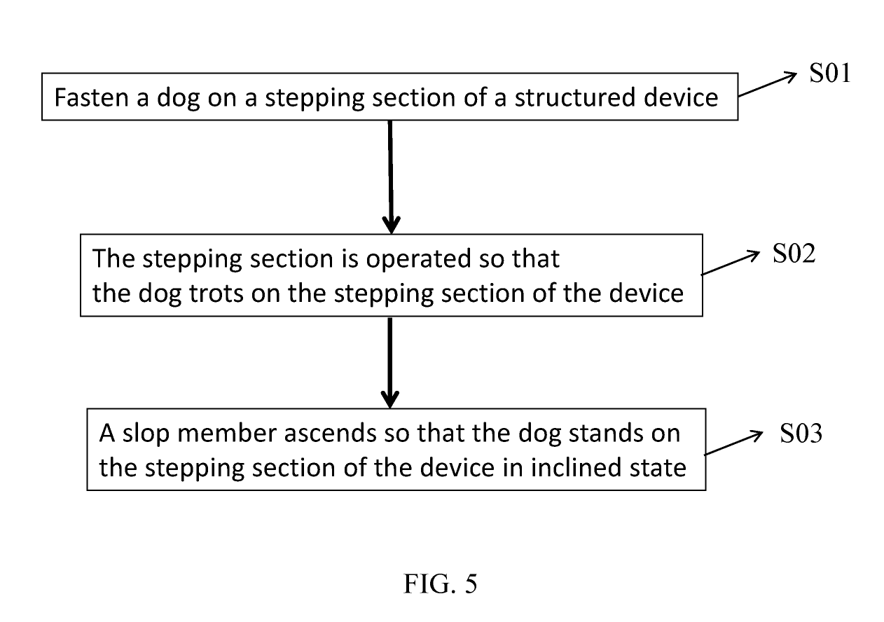

Please refer to FIG. 2, FIG. 4 and FIG. 5. The structured exercise device 1 stated above is utilized. In step S01, fasten a dog on the stepping section 11, the drive member 30 will further operate the stepping section 11 to circle the baseplate 10. In step S02, activate the operation unit 40 to operate the drive member 30 for regulating the operating speed of the stepping section 11 between 0.5˜2 kilometers per hour (0.5˜2 km/h) within 10˜180 seconds so that the dog can perform the aerobic exercise trotting on the stepping section 11 illustrated in FIG. 2. When the time is up, the drive member 30 stops for 5 to 15 minutes for the dog taking a break. In step S03, activate the operation unit 40 to operate the slop member 20 for regulating the inclined angle of the baseplate 10 between 6˜45° within 30˜180 seconds so that the dog can perform resistance training standing on the stepping section 11 in inclined state illustrated in FIG. 4. When the time is up, the operation unit 40 regulates the descending state of the slop member 20 making the baseplate 10 become original level state.

In FIG. 5, steps S02 and S03 may separately proceed 3 to 5 repetitions. The dogs may take a break for 1 to 5 minutes between every repetition.

### Assessment Using the Canine Inflammatory Bowel Disease Activity Index

The effects after implementing the structured exercise device and method thereof for training dogs were evaluated using the Canine Inflammatory Bowel Disease Activity Index (CIBDAI). The severity of six gastrointestinal signs (activity, appetite, vomiting, stool consistency, stool frequency and bodyweight loss) was scored on a scale ranging from 0 to 3. The sum of the scores was then calculated, yielding a total cumulative CIBDAI score. In this invention, all the dogs were kept exclusively indoors; the activity level in this invention was defined as the frequency of active greeting to their owners when they came home and playing with their chew toys. CIBDAI assessment was performed before, after 4 and 10 weeks of prednisolone therapy.

Table 1 is descriptive statistics and CIBDAI scores of 22 dogs with chronic enteropathies.

TABLE 1

| | | Exercise group | | Control group | |
|---|---|---|---|---|---|
| | | (n = 11) | | (n = 11) | |
| Breed | Maltese terrier | 6 | | 7 | |
| | Chihuahua | 2 | | 1 | |
| | Miniature schnauzer | 1 | | — | |
| | French bulldog | 1 | | — | |
| | Mixed breed | 1 | | 3 | |
| Age (years) | | 9.8 ± 2.4 | (6-13) | 9.4 ± 2.0 | (7-13) |
| Sex (female:male) | | (4:7) | | (5:6) | |
| CIBDAI score | Pre-prednisolone treatment | 15.4 ± 1.7 | (12-17) | 15.4 ± 1.6 | (13-18) |
| | 4 weeks of prednisolone | 8.8 ± 1.4* | (6-11) | 9.2 ± 0.9* | (8-11) |
| | treatment | | | | |
| | 10 weeks of prednisolone | 2.4 ± 1.5*†‡ | (0-6) | 9.2 ± 1.1* | (8-11) |
| | treatment | | | | |
| Fecal consistency | Pre-prednisolone treatment | 2.9 ± 0.3 | (2-3) | 2.9 ± 0.3 | (2-3) |
| | 4 weeks of prednisolone | 1.8 ± 0.4* | (1-3) | 2.0 ± 0.3* | (2-3) |
| | treatment | | | | |
| | 10 weeks of prednisolone | 0.9 ± 0.7*†‡ | (0-2) | 2.1 ± 0.1* | (2-3) |
| | treatment | | | | |
| Fecal frequency | Pre-prednisolone treatment | 2.9 ± 0.3 | (1-3) | 2.9 ± 0.1 | (2-3) |
| | 4 weeks of prednisolone | 1.8 ± 0.3* | (0-2) | 1.9 ± 0.3* | (1-2) |
| | treatment | | | | |
| | 10 weeks of prednisolone | 0.9 ± 0.3*†‡ | (0-1) | 1.9 ± 0.3* | (1-2) |
| | treatment | | | | |
| Bodyweight (kg) | Pre-prednisolone treatment | 4.6 ± 2.6 | (2.2-9.1) | 4.8 ± 2.5 | (2.5-9.5) |
| | 4 weeks of prednisolone | 4.6 ± 2.5 | (2.3-9.2) | 4.8 ± 2.6 | (2.5-9.5) |
| | treatment | | | | |
| | 10 weeks of prednisolone | 5.1 ± 2.8*†‡ | (2.6-9.6) | 4.8 ± 2.7 | (2.5-9.4) |
| | treatment | | | | |
| Assessment of weight change between pre- | | +9.2 ± 4.4† | (1.2-16) | −2.2 ± 3.9 | (−9.1 to 0) |
| prednisolone and 10 weeks of prednisolone | | | | | |
| treatment (%) | | | | | |
| Body condition | Pre-prednisolone treatment | 1.5 ± 0.2 | (1-2) | 1.6 ± 0.2 | (1-2) |
| score | 4 weeks of prednisolone | 1.6 ± 0.2 | (1-2) | 1.6 ± 0.2 | (1-2) |
| (five-point | treatment | | | | |
| system) | 10 weeks of prednisolone | 2.6 ± 0.6*†‡ | (2-4) | 1.5 ± 0.6* | (1-2) |
| | treatment | | | | |

| | | | |
|---|---|---|---|
| Mean | Weeks 1~2 | 1 | 1 |
| prednisolone | Weeks 3~4 | 0.8 | 0.8 |
| dosage | Weeks 5~7 | 0.6 | 0.7 |
| (mg/kg/day) | Weeks 8~10 | 0.3 | 0.5 |

Data are presented as n or mean ± sd (range)
*P < 0.05 vs. pretreatment;
†P < 0.05 vs. control group;
‡P < 0.05 vs. first post-treatment

Please refer to Table 1. The control and exercise groups comprised 11 dogs each. The initial prednisolone treatment resulted in improvement in all dogs. After 4 weeks of prednisolone therapy, CIBDAI scores were decreased in the exercise (from 15.4±1.7 to 8.8±1.4) and control (from 15.4±1.6 to 9.2±0.9) groups compared with pretreatment scores. No significant difference was found between groups.

After 10 weeks of prednisolone concomitant with 6 weeks of the structured exercise implementation, the second post-treatment CIBDAI score had decreased significantly in the exercise group (2.4±1.5) compared with the first post-treatment score (8.8±1.4) (P<0.001); in the control group, the first (9.2±0.9) and second (9.2±1.1) post-treatment CIBDAI scores were similar. The second post-treatment CIBDAI scores differed significantly between groups (P<0.001).

After 6 weeks of the structured exercise implementation, all 11 dogs in the exercise group had gained bodyweight (+9.2 percent of baseline bodyweight on average), whereas dogs in the control group showed a mean weight loss of 2.2 percent. Implementation of the present invention significantly affected all six CIBDAI parameters. Bodyweight change (P<0.001, adjusted r²=0.722), activity level (P<0.001, adjusted r²=0.661) and vomiting ((P<0.001, adjusted r²=0.655) were most affected, and stool consistency (P<0.001, adjusted r²=0.523) was least affected. The final statistical model indicated that weight gain was associated with activity level and appetite. The dogs' owners reported no side effect during the 6 weeks of the structured exercise implementation.

Based upon the result of implementing this invention, marked clinical improvement was recorded after utilizing the structured exercise device and method thereof to train dogs with chronic diarrhea; therefore, during medication, implementation of the structured exercise may reduce the dosage.

### Statistical Analysis

The normality of continuous data (age, bodyweight and CIBDAI scores) was assessed using the Kolmogorov-Smirnov test, and these data were summarized as mean values±sds. CIBDAI scores obtained in pretreatment and two post-treatment assessments were investigated in the overall sample and compared between the exercise and control groups using multivariate repeated-measures models for multiple comparisons. Least-squares multiple linear regression analyses were performed with CIBDAI parameter scores as dependent variables and exercise as the independent variable to identify factors affected by the structured exercise. Statistical analyses were performed with commercial statistical software. All tests were two-tailed, and P values <0.05 were considered to be statistically significant.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A structured exercise device for training dogs, comprising:
a baseplate including a stepping section, a peripheral side that laterally delimits space of the stepping section and at least one fixation object which fastens a dog, wherein a plurality of non-slip objects are set on the stepping section;
a slop member arranged at bottom of the baseplate, ascending state of the slop member making the baseplate become 6° to 45° incline;
a drive member arranged on the baseplate, the drive member regulating operating speed of the stepping section; and
an operation unit arranged on the peripheral side or the drive member, the operation unit including a microprocessor and a timer, the operation unit electrically connecting with the slop member and the drive member, the timer coupled with the microprocessor and providing a predetermined time, the microprocessor controlling the ascending or descending state of the slop member or the drive member to operate or stop and to regulate the operating speed of the stepping section within the predetermined time.

2. The structured exercise device according to claim 1, wherein the drive member regulates the operating speed of the stepping section between 0.5 to 2 kilometers per hour.

3. The structured exercise device according to claim 1, wherein the plurality of non-slip objects are multiple grooves, multiple convex tablets or a combination of the multiple grooves and the multiple convex tablets.

4. A method of utilizing a structured exercise device for training dogs, comprising:
fastening a dog on a stepping section, the stepping section operated by a drive member to circle a baseplate;
activating an operation unit to operate the drive member for regulating operating speed of the stepping section so that the dog trots on the stepping section within a first predetermined time, the first predetermined time ending, the drive member stopped; and
activating the operation unit to operate a slop member for regulating inclined angle of the baseplate between 6° to 45° so that the dog stands on the stepping section in inclined state within a second predetermined time, the second predetermined time ending, the operation unit regulating descending state of the slop member.

5. The method according to claim 4, wherein the step of activating the operation unit within the first predetermined time, the drive member regulates the operating speed of the stepping section between 0.5 to 2 kilometers per hour.

6. The method according to claim 4, wherein the step of activating the operation unit within the first predetermined time, the first predetermined time is set between 10 seconds to 3 minutes.

7. The method according to claim 4, wherein the step of activating the operation unit within the first predetermined time, the drive member stops for 5 to 15 minutes.

8. The method according to claim 4, wherein the step of activating the operation unit within the first predetermined time proceeds 3 to 5 repetitions.

9. The method according to claim 4, wherein the step of activating the operation unit within the second predetermined time, the second predetermined time is set between 30 seconds to 3 minutes.

10. The method according to claim 4, wherein the step of activating the operation unit within the second predetermined time proceeds 3 to 5 repetitions.

11. The method according to claim 4, wherein a plurality of non-slip objects are set on the stepping section.

12. The method according to claim 11, wherein the plurality of non-slip objects are multiple grooves, multiple convex tablets or a combination of the multiple grooves and the multiple convex tablets.
